(19) United States
(12) Patent Application Publication
(10) Pub. No.: US 2025/0334096 A1
(43) Pub. Date: Oct. 30, 2025

(54) WAVE ENERGY CONVERTER

(71) Applicant: WAVE MINING SOLUTIONS LIMITED, London (GB)

(72) Inventor: Olivier BOURDIN, London (GB)

(73) Assignee: WAVE MINING SOLUTIONS LIMITED, London (GB)

(21) Appl. No.: 18/879,389

(22) PCT Filed: Jun. 27, 2023
(86) PCT No.: PCT/EP2023/067516

§ 371 Date: Dec. 27, 2024

(30) Foreign Application Priority Data
Jun. 28, 2022 (EP) 22181618.4

(51) Int. Cl. F03B 13/24

(52) U.S. Cl. CPC F03B 13/24; F03B 13/148; F03B 13/188

(57) ABSTRACT

A wave energy converter having at least one energy transmitting device configured to be disposed within a granular medium and including: a flexible envelope forming an internal volume and having an upper surface and a lower surface; at least one inflatable element configured to contain a fluid and housed in the internal volume so as to be interposed between the upper surface and the lower surface; and at least one energy converting device associated to at least one of the inflatable elements and configured to produce energy upon actuation; wherein the wave energy converter is configured to actuates the at least one energy converting device when a wave impinging on the energy transmitting device.

### FIELD OF INVENTION

The present invention relates to a wave energy converter.

### BACKGROUND OF INVENTION

With present concerns over global warming, carbon emissions and limited availability of traditional fossil fuels, it becomes compulsory to turn to sources of alternative, renewable, energy such as solar, wind and wave power. Extracting energy from the waves does not require much space, does not pollute, does not create much noise, does not put stress on the power grid, and happens mostly out of sight. It is thus desirable to convert wave energy to electrical energy.

Although the extraction of energy from waves, using wave energy converters is known, said wave energy converters have yet to be satisfactory and able to produce electrical energy at affordable prices.

Indeed, during the last few years, a specific kind of wave energy converters known as submerged pressure differential wave energy converters (SPDWECs) have demonstrated an ability to reduce costs and externalities. Unfortunately, they remain too expensive because like most wave energy converters, they involve large metallic structures that are expensive to manufacture, to transport, to anchor on the seabed, and to maintain.

Moreover, most of the SPDWECs are installed in relatively deep water (10 meters or more) to reduce the risk of damage on the structure which may be caused by large waves. This deep installation also greatly reduces the amount of energy that can be extracted from the waves, because this energy decreases sharply as depth increases. This also reduces the possibility to install the SPDWECs close to the shore or in the foreshore, thereby increasing the installation, maintenance and connection costs.

Furthermore, existing SPDWECs have only limited ability to change their configuration (height, curvature, orientation of the active elements) according to the size of the waves. Consequently, the amount of energy extracted from the waves is not optimized. Moreover, in the case of large waves or large storms, the SPDWECs become vulnerable as they cannot change their overall configuration, leading to possible damage to the structure. Also, installing them close to coasts with high tidal ranges such as Western Europe is challenging because they are likely to be covered by either too much or too little water to operate safely or efficiently.

Thus, there is a need for a wave energy converter allowing optimized wave energy conversion, whatever the size of the waves, which can be installed in relatively shallow water without being damaged by heavy seas, and can be installed close to the shore for cost and ease of maintenance, even when the tidal range is important.

A purpose of this invention is therefore to provide a wave energy converter presenting an energy recovery configuration allowing to extract the energy from waves. Moreover, the wave energy converter of the invention is nearly totally flexible, allowing it to be disposed in (within) a granular medium and to be vertically displaced within the granular medium. Said wave energy converter is more efficient at extracting the energy from waves, can avoid the need for big metallic structure by being embedded in sediments and using the sediments as casing and protection, is less expensive to manufacture, install and maintain, and/or reduces the risk of damage in case of large waves or storms.

### SUMMARY

To this end, the present invention relates to a wave energy converter comprising at least one energy transmitting device configured to be disposed within a granular medium, such as sand or sediment, the energy transmitting device comprising:
a flexible envelope forming an internal volume and comprising an upper surface and a lower surface;
at least one inflatable element configured to contain a fluid and housed in the internal volume so as to be interposed between the upper surface and the lower surface; and
at least one energy converting device associated to said at least one inflatable element and configured to produce energy upon actuation;
   wherein the energy transmitting device presents an energy recovery configuration allowing a deformation of the flexible envelope towards said at least one inflatable element to deform said at least one inflatable element when a wave impinging on the energy transmitting device flows over said flexible envelope, so that said deformation of the flexible envelope actuates the at least one energy converting device.

Indeed, since the energy transmitting device is disposed within (in) the granular medium, there is no need of dedicated securing devices. The energy transmitting device is secured within the granular medium thanks to the configuration of the flexible envelope, especially thanks to the edges of said envelope extending outwardly at the joint between the upper and lower surfaces. This advantageously reduces the cost and the difficulties of installation. For example, the energy transmitting device can also be installed in mud, in which fixation means such as pegs or anchors do not work well.

Furthermore, the energy transmitting device mostly comprises light flexible structures. This allows a reduction of the cost of manufacturing, transport and decommissioning.

Finally, the energy converting device allows to use the wave energy converter as a source of renewable energy to produce electricity and/or mechanical energy from the energy of waves.

According to other advantageous aspects of the invention, the energy converting device comprises at least one cylinder comprising a piston disposed within the inflatable element and a chamber receiving a part of the piston, a deformation of the flexible envelope increasing pressure on the piston thereby actuating the at least one energy converting device.

Indeed, the cylinder is cheaper and smaller than turbines. This leads to a wave energy converter which is cheaper to manufacture and easier to install.

According to other advantageous aspects of the invention, the energy converting device comprises an electroactive polymer or elastomer allowing the conversion of the mechanical deformation of the flexible envelope by the impinging of the wave into electricity.

This advantageously reduces complexity and maintenance of the wave energy converter.

According to other advantageous aspects of the invention, each inflatable element comprises an outlet and the at least one energy converting device is in fluidic connection with said at least one of inflatable element via the outlet and wherein the deformation of the flexible envelope towards said at least one of inflatable element in fluidic connection with the at least one energy converting device increases pressure on the fluid and forces it out of said at least one inflatable element at the outlet to actuate the at least one energy converting device.

According to other advantageous aspects of the invention, the energy transmitting device is configured to switch from a protection configuration in which at least one inflatable element is inflated so that a first distance is measured between the upper surface and the lower surface to the energy recovery configuration in which said at least one inflatable element is inflated so that a second distance is measured between the upper surface and the lower surface, the second distance being greater than the first distance, and vice-versa.

The disposition of the energy transmitting device within the granular medium and the capacity to switch to the protection configuration advantageously provide a protection of the surfaces of the energy transmitting device against damages that may be caused by large waves and storms. Indeed, in the protection configuration, the energy transmitting device may be completely deflated and lay flat under the sea bed, typically under one to three meters of sediments. Therefore, the device is in a safe configuration wherein waves of large amplitude cannot damage the surfaces and wherein the device cannot be carried away by currents. This also means that the device can be installed in relatively shallow water or in places with a large tidal range if needed. Moreover, this allows to reduce the disturbance of the natural wildlife and allows other activities to be performed on the same site such as fishing, surfing, etc.

The ability to switch from the protection configuration to the energy recovery configuration, and vice versa, allows to adapt the form of the energy transmitting device according to the size of the wave and to the tide in order to maximize the energy extracted from the waves. Indeed, when waves of small amplitude impinge the energy converting device, the distance between the upper and the lower surfaces (and thus the elevation of the upper surface) can be increased thereby exposing a greater area of the upper surface above the granular medium, and decreasing the distance between the upper surface and the waves in order to extract more energy from these small waves. In the same manner, when waves of large amplitude impinge the energy converting device, the distance between the upper and the lower surfaces is decreased thereby decreasing the area of the upper surface that can pick up energy, and increasing the distance between the upper surface and the waves in order to extract energy from these waves without damaging the upper surface.

According to other advantageous aspects of the invention, in the protection configuration the upper surface has a first curvature, in the energy recovery configuration the upper surface has a second curvature greater than the first curvature.

Varying the curvature of the upper surface allows to adapt the orientation of the energy transmitting device to the size of the waves thereby increasing the energy extraction efficiency. Moreover, providing a curvature to the energy converting device allows to extract energy from both the vertical (heave) and horizontal (surge) components of the wave force, which is particularly important when the waves are small.

According to other advantageous aspects of the invention, in the protection configuration, the upper surface is covered by a layer of granular medium having a first height and, in the energy recovery configuration, the upper surface is at least partially covered by a layer of granular medium having a second height, the second height being smaller than the first height.

At least partially covering the upper surface with a layer of granular medium and modifying the height of this layer allows to extract the energy from the waves thanks to the fluidic behavior of the granular medium while protecting the surface of the energy transmitting device. Indeed, when the layer of sediment above the device is thin, for example, a few centimeters, the layer of sediment can have a fluidic behavior when set in motion. In this situation, the layer of sediment allows wave energy to reach the device, while offering some amount of protection. When the layer of sediment above the device is thicker, for example one meter of more, it will not allow wave energy to reach the device, but will offer a very good protection against violent conditions.

According to other advantageous aspects of the invention, the wave energy converter further comprises at least one transportation pipe comprising a proximal end being in fluidic connection with the outlet of said at least one inflatable element and a distal end being in fluidic connection with the energy converting device so that the fluid is transported from said at least one inflatable element to the energy converting device through the transportation pipe.

The transportation pipe allows to dispose the energy converting device away from the energy transmitting device thereby facilitating the control and maintenance of the energy converting device.

According to other advantageous aspects of the invention, the energy transmitting device is further configured to switch from the protection configuration or the energy recovery configuration to an ascent configuration in which the inflatable element is inflated so that the distance between the upper surface and the lower surface is larger than the second distance so as to elevate both the top and the bottom part of the edges of the envelope for allowing the energy transmitting device to ascend through the granular medium.

The ascent configuration allows the energy transmitting device to go up vertically within the granular medium in which it is buried, thereby permitting to position it more superficially, or making it emerge therefrom, without digging the granular medium and without the need to use other types of equipment in order to retrieve the device which can be difficult when the seabed is covered by water. Adjusting the vertical position upwards can be useful for example if currents have deposited new sediments over the installation location, and the depth of burial is becoming too important for the device to be used or to be able to extract energy from the waves when inflated.

According to other advantageous aspects of the invention, the wave energy converter further comprises a measuring device for measuring the height of the layer of granular medium above the energy transmitting device, the measuring device comprising at least one pressure sensor.

The measuring device allows to adapt, in real-time, the height and/or the curvature of the upper surface in order to increase the energy extraction efficiency.

According to other advantageous aspects of the invention, the energy transmitting device further comprises a burying device, said burying device comprising a pressurized fluid generator and at least one outlet configured to inject the pressurized fluid into the granular medium below the lower surface of the envelope to allow the energy transmitting device to descend through the granular medium.

This embodiment advantageously allows to obtain a self-burying device.

According to other advantageous aspects of the invention, the flexible envelope is leak-tight, so as to impede the passage of the granular medium therethrough.

This embodiment is advantageous to prevent particles of the granular medium from entering and accumulating inside the envelope. This is likely to happen during the inflation phases, when the volume inside the envelope increases. This therefore allows to avoid any damage to the inner equipment sensitive to particles, such as for instance sensors, and to prevent sediments from accumulating inside the envelope. For instance, the envelope may also be made of a waterproof material, which impedes the entry of both granular medium and water in the internal volume.

According to other advantageous aspects of the invention, wave energy converter further comprises an injection device configured to fill the inflatable element with the fluid and comprising at least one feeding pipe comprising an upstream portion adapted to receive a fluid and a downstream portion connected to the inflatable element, the upstream portion and the downstream portion being connected to each other by a bend and/or the upstream and downstream portions comprising micronozzles, so as to prevent kinking of the feeding pipe between the upstream and the downstream portion.

The bend and micronozzles are particularly advantageous when the energy transmitting device is buried at non-negligible depth, to avoid the pipe from kinking when it is pulled down by the envelope, thereby preventing the inflation or deflation of the inflatable element, and to allow movement of the pipe in the granular medium.

According to other advantageous aspects of the invention, energy transmitting device further comprises an additional inflatable element positioned below or embedded in the lower surface of the envelope and a pressurized fluid generator for inflating the additional inflatable element with a fluid, wherein in the ascent configuration said additional inflatable element is inflated so as to elevate the lower surface to allow the energy transmitting device to ascend through the granular medium.

According to other advantageous aspects of the invention, the energy converting device comprises an electricity generator.

According to other advantageous aspects of the invention, the wave energy converter further comprises an assembly of at least two energy transmitting devices, the assembly being fluidically connected to at least one energy converting device via the outlet of the inflatable elements.

This assembly is particularly advantageous when the two energy transmitting devices are located at different cross-shore locations because it increases the average pressure difference between the inflatable elements of the devices, and therefore increases the amount of energy that can be converted from the kinetic energy of the fluid circulating between the devices.

The present invention also relates to a method of converting wave energy into electricity and/or mechanical energy using the wave energy converter described above, the method comprising the steps of burying the at least one flexible envelope comprising a fluid in the internal volume at a predetermined depth in a granular medium, and a step of converting the wave energy into mechanical energy and/or electricity with the at least one energy converting device when a wave flows over said flexible envelope.

This method may advantageously use a wave energy converter as described above to provide mechanical energy and/or electricity.

According to other advantageous aspects of the invention, the method of converting wave energy further comprises a step of vertically displacing the flexible envelope, said step comprising:
ascent by vertically deforming the flexible envelope; and/or
descent by injecting a pressurized fluid into the granular medium below the flexible envelope.

According to other advantageous aspects of the invention, the method of converting wave energy further comprises a step of varying the internal volume by inflating or deflating the flexible envelope.

### Definitions

In the present invention, the following terms have the following meanings:

“Distance between the upper surface and the lower surface” refers to the largest distance between the two surfaces.

“Edges” refers to the part of the envelope wherein the upper surface is superimposed on the lower surface, the upper part of an edge referring to the superimposed upper surface and the lower part of an edge referring to the superimposed lower surface. In case there is a single inflatable element, the edges are the part of the envelope wherein the inflatable element does not lay between the upper and the lower surface. Or, if there are several inflatable elements, the part of the envelope wherein the upper and lower surfaces are only separated by inflatable elements that are not inflated as part of the current operation.

“Height of the layer of granular medium” refers to the smallest distance between the upper surface of the energy transmitting device and the upper surface of the granular medium lying above the energy transmitting device.

“Layer of granular medium” refers to the layer of granular medium lying above the upper surface of the energy transmitting device. It is defined by a lower surface contacting the upper surface of the energy transmitting device and by an upper surface at the interface between the granular medium and the water.

“Substantially horizontal” refers to the general orientation of the lower surface in the protection configuration and energy recovery configuration. The center and the edges (or border) of the lower surface may form an angle of maximum 20°.

### DETAILED DESCRIPTION

This invention relates to a wave energy 100 converter comprising:
at least one energy transmitting device 1 configured to be disposed within a granular medium 2, such as sand or sediment, the energy transmitting device comprising:
   a flexible envelope 11 forming an internal volume 110 and comprising an upper surface 11a and a lower surface 11b;
   at least one inflatable element 12 configured to contain a fluid and housed in the internal volume 110 so as to be interposed between the upper surface 11a and the lower surface 11b; and
at least one energy converting device 17 associated to said at least one inflatable element 12 and configured to produce energy upon actuation.

FIG. 1 schematically illustrates the wave energy converter 100 of the invention, according to a preferred embodiment.

The envelope 11 may comprise two sheets (for instance two tarpaulins) joined together on their border (or extremities). The two sheets may be made of different materials in order to provide different properties to the upper and lower surfaces (11a, 11b). Preferably, the two sheets join together at their border. The edges 111 created by the inward superposition of the upper and lower surfaces thus extends outwardly so that they can act as an anchor in the granular medium 2 as represented in FIGS. 2A-2B, 3A-3B and 5B.

The energy transmitting device 1 may be configured to switch from a first configuration (FIG. 2A) in which at least one of the inflatable elements 12 is inflated so that a first distance is measured between the upper surface 11a and the lower surface 11b to the second configuration (FIGS. 2B and 2C) in which said least one inflatable element 12 is inflated so that a second distance is measured between the upper surface 11a and the lower surface 11b, the second distance being greater than the first distance.

Preferably, in the first configuration, the at least one inflatable element 12 is completely deflated and lay flat under the sea bed, typically under one to three meters of sediments. This advantageously provides a protection of the surfaces of the energy transmitting device against damages that may be caused by large waves and storms. This first configuration is thus named, in the following description, as the protection configuration.

The energy transmitting device 1 thus presents the second configuration which allows a deformation of the flexible envelope 11 towards the at least one inflatable element 12 to deform said at least one inflatable element 12 when a wave impinging on the energy transmitting device 1 flows over said flexible envelope 11, so that said deformation of the flexible envelope 11 actuates the at least one energy converting device 17. More precisely, the deformation of the flexible envelope 11 assists conversion of potential and kinetic energy of the wave into mechanical energy and/or electricity 172 via the at least one energy converting device 17. This second configuration is thus named, in the following description, as the energy recovery configuration.

The energy transmitting device 1 may further comprise at least one pressure management unit configured to be inflated or deflated allowing the switching from the protection configuration to the energy recovery configuration. For example, each pressure management unit is configured to manage the pressure within at least one of the inflatable elements as a function of the different configuration. Each pressure management unit may further comprise pressure adjustment device to supply the inflatable element with fluid or remove fluid from the inflatable element 12.

The energy transmitting device 1 may further comprise at least one fixed volume element in fluidic communication with the internal volume 110 of the flexible envelope 11 and configured to be adapt the pressure of the internal volume 110 so that to ease the deformation of the upper surface 11a.

As can be seen in FIGS. 2A-C, the energy transmitting device 1 may be further configured so that the lower surface 11b remains stable and substantially horizontal in the protection configuration and energy recovery configuration. Therefore, the lower surface 11b of the envelope 11 does not ascend or descend in the protection configuration and energy recovery configuration. This provides stability to the energy transmitting device 1, and further ensures that it remains at the same depth inside the granular medium 2 while switching between the protection configuration and energy recovery configuration.

Unless otherwise specified, the terms “lower”, “upper”, “above”, “under”, “below” are intended with respect to the position of the energy transmitting device 1 when it is in its in-use configuration.

The granular medium 2 may be any medium submerged in an area of water. It is an assembly of solid particles, such as mud, sand, sediments, soil. Preferably, the granular medium 2 is sand such as for example coarse sand, medium sand, fine sand, very fine sand, or silt such as for example coarse silt or medium silt. Granular media are often made of macroparticles (i.e., larger than 100 micrometers); however, they may also comprise finer particles, as it is the case for silt and fine sand.

The area of water over the granular medium into which the energy transmitting device 1 is disposed in preferably an area of open water into which waves are formed. Preferably, the heigh of water above the energy transmitting device 1 ranges from 1 and 30 meters.

The energy transmitting device 1 is advantageously adapted to be installed both close to the shore and in open sea. Having the energy transmitting device 1 disposed close to the shore allows to ease the maintenance of said device and to reduce the cost of connecting it to the power grid.

Advantageously, the energy transmitting device 1 is flexible, is disposed within the granular medium 2 and is not secured to the granular medium 2. This is advantageous compared to devices fixed (secured) onto a river bed concrete or on the seabed. Indeed, devices where the envelope is fixed to the seabed need anchor bolts, preferably a plurality of rows of anchor bolts, or other types of anchoring devices. Such anchored devices prevent the vertical displacement of the device, and thus it cannot vary the degree of protection offered by the granular medium, or adapt to movements of the granular medium (for example during storms). On the contrary, the energy transmitting device 1 of the invention is disposed within (inside) the granular medium 2 without any anchoring element thereby reducing the cost of installation and removal. Advantageously, the energy transmitting device 1 comprises edges acting as an anchor, and that are maintained in place by the friction and the pressure exerted by the granular medium. The edges 111 may be more or less long according to the needed maintainability. This removes the need for additional anchoring elements. Moreover, the absence of additional anchoring elements allows the vertical displacement of the energy transmitting device 1 within the granular medium 2.

The dimension of the upper surface 11a is thus preferably calculated so that the lower part of the edges 111 does not move when the energy transmitting device switches between the protection configuration to the energy recovery configuration. The second distance and the second curvature are thus also preferably small enough so that the edges are not pulled upwards. Preferably, the upper surface 11a and the lower surface 11b of the envelope 11 have an area which is larger than 1 square meter, even more preferably larger than 5 square meters.

For instance, these surfaces may have a width comprised between 1 meter and 20 meters, and a length comprised between 1 meter and 50 meters. The width and the length may be similar, or one of these dimensions may be larger than the other one.

In one embodiment, the upper surface 11a and the lower surface 11b have the same area. In this alternative embodiment, the envelope 11 may have a polygonal shape, in which each corner is connected to at least another corners (for example, with straps) in order to bring the connected corners closer to each other, and obtain a folded configuration. In this embodiment, the edges of the upper and lower surfaces 11b are preferably folded inwardly (i.e., towards the internal volume 110) in the protection configuration. When the energy transmitting device 1 is in its energy recovery configuration, the upper surface 11a is raised vertically and said edges are unfolded, whereas the lower surface 11b remains substantially horizontal. Having an energy transmitting device 1 with folded edges in the protection configuration is particularly advantageous for envelopes 11 of large dimensions, for instance having upper and lower surfaces 11b larger than 5 square meters. Indeed, the folding of the edges allows to reduce the space occupied by the energy transmitting device 1 when it is in the protection configuration, when laid flat or during its initial descent in the granular medium. In this the embodiment, the envelope 11 may be made of a single body. The envelope 11 may be attached to an inner surface tarpaulin.

In an alternative embodiment shown in FIGS. 1 to 4B, the upper surface 11a of the envelope 11 may have an area which is greater than the area of the lower surface 11b. The envelope 11 thus comprises two sheets (for instance two tarpaulins) joined together on their edges (or extremities or border). In this case, the two sheets may be made of different materials in order to provide different properties to the upper and lower surfaces (11a, 11b). Preferably, the two sheets join together at their border. The edges 111 created by the inward superposition of the upper and lower surface thus extends outwardly so that they can act as an anchor in the granular medium 2 as represented in FIGS. 2A-2B, 3A-3B and 5B.

The surface of the at least one inflatable element 12 may be smaller than the area of the upper surface 11a. This allows said element 12 to be inflated so as to reach configuration 2 without pulling upwards on the bottom part of the edges of envelope 11. Preferably, the edges 111 extend on a length of more than 10% of the length of the surface where the upper surface 11a and lower surface 11b are not joint. In other words, the ratio between the length of the upper surface 11a and the length of said inflatable element 12 is at least 1.1 and the ratio between the width of the upper surface 11a and the width of said inflatable element 12 is at least 1.1, so that said inflatable element 12 occupies only a portion of the space available in envelope 11 when in the energy recovery configuration and does not create a tension on the upper surface 11a that would result in said upper surface to pull the edges 111 upwards, which would result in a tension force on the lower surface of the edges. In other words, the length and the width of the upper surface 11a are at least equal to 110% of the length and the width of said inflatable element 12, respectively. This allows for an enhanced stability of the energy transmitting device 1 within the granular medium 2.

The envelope 11 is advantageously made of a flexible material, such as coated textile, fabric or non-woven fabric.

Examples of suitable materials for the envelope 11 include, without limitation: plastic polymers such as PVC or polypropylene. For instance, it may be made of waterproof materials.

Advantageously, the envelope may form a barrier to the granular medium 2 (leak-tight), to water, or both.

If the envelope is not configured to totally obstruct the passage of granular medium 2, a filtering material may advantageously be used in places where different parts of the envelope are fitted together, and at the connection between the envelopes and the tubes, in order to avoid the entry of particles in the internal volume 110.

The energy transmitting device 1 may be configured to switch between the protection configuration and the energy recovery configuration and vice-versa. Advantageously, the modification of the internal volume is only controlled by the inflation or deflation of at least one inflatable element 12 or, if present, by the inflation or deflation of the pressure management unit. In other words, the internal volume is not modified by injection of fluid directly inside the envelope 11 (i.e., outside the inflatable element 12). Compared to devices where the flexible envelope is inflated or deflated through the supply or drain of the fluid with a fluid supply-drain means connected to the flexible envelope and the inflatable element, the configuration of the energy transmitting device 1 of the invention allows to supply fluid only into the inflatable element 12 or, if present, by the inflation or deflation of the pressure management unit. This allows the edges 111 of the envelope 11 to be used as an anchor, which would not be possible if the whole volume of the envelope 11 was inflated, as opposed to only the central area. Moreover, this also increases reliability, as the envelope 11 can get worn or punctured due to the abrasive action of the granular medium. In this case, the inflatable element may still continue to extract energy from the waves while waiting for the replacement of the flexible envelope. In case of failure of the inflatable elements 12, it may be useful to inflate the envelope 11 to raise the device 1 so that the damaged inflatable elements 12 can be repaired.

The energy transmitting device 1 may be further configured so that in the protection configuration the upper surface 11a has a first curvature whereas in the energy recovery configuration the upper surface 11a has a second curvature greater than the first curvature as represented in FIG. 2. This is advantageous because changing the curvature of the upper surface 11a allows to adapt the orientation of the energy transmitting device 1 with respect to the direction and the force of the waves thereby increasing the efficiency of the extraction of the energy from the waves. When a substantial fraction of the upper surface 11a forms an angle of about 45°, the energy extracted from the wave is advantageously maximized.

Advantageously, in the protection configuration, the upper surface 11a may be covered by a layer of granular medium 2 having a first height h_{G} (FIG. 2A) and, in the energy recovery configuration, the upper surface 11a may be covered by a layer of granular medium 2 having a second height (FIGS. 2B and 2C), the second height h_{G} being smaller than the first height h_{G}. This is advantageous because, when the upper surface 11a is covered by a thin layer of granular medium (FIG. 2B), since the layer of granular medium is put in motion thanks to the movement of the waves, the granular medium behaves like a fluid thereby transmitting at least part of the energy from the waves while protecting the upper surface from any damage. Moreover, when the second height h_{G} is equal to zero, the upper surface is emerging, at least partially, from the granular medium (FIG. 2C), i.e. at least one point of the upper surface is not covered by the granular medium thus emerging from it. This is advantageous because the energy carried by the waves is not mitigated by the layer of granular medium 2 above the upper surface 11a. Therefore, modifying the height of this layer allows to maximize the energy extracted from the wave by decreasing the height of the layer of granular medium (and possibly emerging from the granular medium) when waves of small amplitude occur and increasing the height of the layer of granular medium when waves of large amplitude occur. Moreover, increasing the height of the layer of granular medium when waves of large amplitude occur allows to protect the upper surface from any damage which may be cause by these large waves.

To switch between the protection configuration and the energy recovery configuration, at least one of the inflatable elements 12 may occupy a first volume in the protection configuration and a second volume greater than the first volume in the energy recovery configuration as represented in FIG. 2. To do so, the wave energy converter further comprises an injection device 13 configured to fill said inflatable element 12 with the fluid, or to empty the same during the initialization of the energy transmitting device 1 before its first use. Said fluid is may be air or water. The inflation and deflation of the inflatable element 12 respectively allow to increase and decrease the internal volume 110. During the use of the energy transmitting device 1, the filling or emptying of the inflatable element 12 may be performed by the pressure management unit.

For instance, the injection device 13 may be a compressor (for example a rotary screw compressor), a blower (for example a side channel blower) or a pump (for example a centrifugal pump).

The injection device 13 may be fluidly connected with a storage tank comprising the fluid, such as air or water (not illustrated).

The injection device 13 may comprise a feeding pipe 131 for conducting the fluid to the inflatable element 12. Preferably, the pipe 131 is flexible so that it can follow the movements of the energy transmitting device 1 inside the granular medium 2. In the example of FIG. 1, the feeding pipe 131 passes through the lower surface 11b of the envelope 11. In an alternative embodiment (not illustrated) the feeding pipe 131 may pass through the envelope 11 where the upper surface 11a and the lower surface 11b meet. By providing a feeding pipe 131 that passes through the lower surface 11b, or through a position in which the upper and lower surface 11b meet, it is possible to avoid damages to said pipe 131 or other problems which may be caused by the movements of the upper surface 11a.

The feeding pipe 131 may comprise an upstream portion, adapted to receive the fluid, and a downstream portion, connected to the inflatable element 12. Preferably, said portions are connected by means of a bend 133. This allows to increase the resistance to deformation of the feeding pipe 131 at the bend location. This is particularly advantageous when the energy transmitting device 1 is buried relatively deeply, as it impedes that the pipe collapses under the weight of the superimposed granular medium 2. Moreover, the local rigidity provided by the bend 133 ensures that the pipe easily follows the movements of the energy transmitting device 1 inside the granular medium 2. Alternatively or in combination, the portions may comprise micronozzles allowing to fluidify the granular medium disposed in the vicinity of the feeding pipe 131 thereby preventing the kinking of the feeding pipe 131 when the energy transmitting device 1 is ascending or descending vertically. To allow easier movements in the granular medium 2, some sections of the feeding pipe 131 can be a lay flat hose, which occupy less space while deflated.

As can be seen in FIG. 1, the injection device 13 may also comprise a valve 134 to control the circulation of the fluid inside the feeding pipe 131. This valve 134 is preferably located proximal to the injection device 13, so that it is easily accessible for maintenance purposes.

The wave energy converter 100 may further comprise an additional device configured to send the fluid back to the inflatable element 12 thereby allowing the fluid to move in a closed-loop system.

In addition to the protection configuration and the energy recovery configuration, energy transmitting device 1 may be further configured to switch to a third configuration. This third configuration allows the vertical ascent of the energy transmitting device 1 inside the granular medium 2. This third configuration is thus named, in the following description, as the ascent configuration.

The third configuration is shown in FIGS. 4A and 4B. The third configuration differs from the protection configuration and energy recovery configuration in that the lower surface 11b of the envelope 11 is vertically deformed, thereby allowing the energy transmitting device 1 to ascend through the granular medium 2.

For instance, as shown in FIG. 4A, at least one of the inflatable elements 12 may be inflated so that the distance between the upper surface 11a and the lower surface 11b is larger than the second distance.

This configuration allows to elevate the edges 111 of the envelope 11 (in particular the bottom part of the edges) thereby creating an available volume below the lower surface 11b which can be occupied by the granular medium 2 (as schematically illustrated by the black arrow in FIG. 4A). In particular, the edges 111 of the envelope 11 (in particular the bottom part of the edges) are elevated thanks to the tension created on the upper surface 11a by the inflation of said inflatable element 12. As the granular medium 2 migrates and occupies said volume, the raised energy transmitting device 1 cannot further descend due to the presence of the granular medium 2 which has migrated below the lower surface 11b. Once granular medium has moved below the edges 111 of the envelop 11, deflating the inflated elements 12 configured to be inflated or deflated creates a void underneath the envelope. This void is partially filled by said granular medium as the deflation occurs. For large devices, the process can be accelerated by injecting water under the lower surface 11b while one of the inflatable elements 12 used to switch in the ascent configuration is being deflated or inflated for the purpose of upward migration. For intelligibility purposes, only the migrated medium 2 is depicted in FIGS. 4A and 4B, the layer of granular medium 2 above the upper surface 11a of the envelope 11 is not illustrated.

In this configuration, said inflatable element 12 may occupy a third volume greater than the second volume. The third volume may be selected on the basis of the difference between the current depth of the energy transmitting device 1, and a target depth. In this case, one or more sensors may be provided on the energy transmitting device 1 to measure its depth (or the height h_{G} of the granular medium 2 above the upper surface 11a).

Moreover, the switching between the protection configuration or energy recovery configuration and the ascent configuration may be repeated several times. In this case, the ascension of the energy transmitting device 1 within the granular medium 2 is intermittent. This embodiment is particularly advantageous for large vertical displacements (for instance for causing an energy transmitting device 1 which is buried relatively deeply in the granular medium 2 to ascend closer to the surface of the same, or completely emerge therefrom).

Moreover, in this embodiment, the characteristics of each configuration of the energy transmitting device 1 (e.g., the first, second and third volumes) are independent of the target displacement of the energy transmitting device 1. In other words, the configurations of the energy transmitting device 1 do not need to be modified based on the extent of the desired displacement, and only the number of repetitions of the switching between one configuration to another is modified.

Such number of repetitions may be calculated for instance based on the maximum height of the inflatable element 12 used to switch in the ascent configuration (i.e., its height when fully inflated), the ratio between said maximum height and the length of the upper surface 11a in each horizontal dimension (length and width), and the depth at which the energy transmitting device 1 is buried.

When the energy transmitting device 1 does not comprise the pressure management unit and comprises only one inflatable element 12, the inflatable element 12 is inflated or deflated to allow switching from the protection configuration to the energy recovery configuration and is deformed to provide electricity 172, and is inflated to switch towards the ascent configuration. In a second embodiment, wherein the energy transmitting device 1 comprises at least two inflatable element 12 (without pressure management unit), some of the inflatable elements 12 may be configured to be inflated or deflated allowing to switch between the protection configuration, the energy recovery configuration and the ascent configuration whereas other inflatable elements 12 actuates the at least one energy converting device 17. In a third embodiment, when the energy transmitting device 1 comprises at least three inflatable element 12 (without pressure management unit), some of the inflatable elements 12 may be configured to be inflated or deflated, making it possible to switch from the protection configuration to the energy recovery configuration and vice-versa, other inflatable elements 12 are configured to be inflated or deflated, allowing to switch to the ascent configuration whereas other inflatable elements 12 actuates the at least one energy converting device 17. In this second and third embodiments, the inflatable element 12 has preferably a maximal volume determined to not switch in the ascent configuration when said inflatable element 12 is totally inflated. Moreover, in the third embodiments, the inflatable elements 12 configured to be inflated to reach the ascent configuration may have a maximal volume larger than the inflatable elements 12 configured to be inflated or deflated in order to switch from the protection configuration to the energy recovery configuration. In a fourth embodiment wherein the energy transmitting device 1 comprises a pressure management unit, the pressure management unit may be inflated or deflated allowing to switch between the protection configuration, the energy recovery configuration and the ascent configuration whereas the inflatable elements 12 actuates the at least one energy converting device 17.

FIG. 4B illustrates the ascent configuration according to an alternative embodiment, in which the energy transmitting device 1 comprises one or more additional inflatable elements 18.

In this example, the vertical deformation of lower surface 11b and of the edges 111 of the envelope 11 (in particular the bottom part of the edges 111) in the ascent configuration (and, consequently, the vertical ascension of the energy transmitting device 1) is provided by the inflation of said additional inflatable element 18 via the pressurized fluid generator 182.

The additional inflatable element 18 may be attached to the lower surface 11b, for example under the lower surface 11b.

Alternatively, the lower surface 11b may be made of a double layer, and the additional inflatable element 18 may be embedded within said layers (as shown in FIG. 4B).

The energy transmitting device 1 may further comprise one of more sensors. For instance, the energy transmitting device 1 may comprise one or more of the following sensors:
a pressure sensor 16 (such as the Seametric PS9800);
a flowmeter or a velocimeter (such as the Mass Flow MV-308);
a tilt sensor (such as the Shanghai Zhichuan Electroni ZCT205M-LPS);
an acoustic sensor, preferably a hydrophone (such as the Aquarian AS-1);
a force sensor (such as the Interlink 402);
an imaging sensor.

These sensors advantageously allow to measure environmental parameters, for instance parameters characterizing the granular medium 2 or the flow of water above the envelope 11. Examples of environmental parameters comprise flow, velocity or turbulence of the water, wind speed and direction, pressure exerted by the water and/or the granular medium 2 above the energy transmitting device 1, and the like.

The pressure sensor 16 may be an internal sensor or an external sensor. When the pressure sensor 16 is an internal sensor, it is in fluidic connection with the feeding pipe 131 or the pressure management unit so that it measures the pressure inside the inflatable element 12. The internal pressure sensor 16 can be located far from the energy transmitting device 1, for example on the beach. An external pressure sensor 16 is configured to measure the flow parameters close to the energy transmitting device 1. Consequently, the external pressure sensor 16 should be installed close to the energy transmitting device 1.

For instance, at least one pressure sensor 16 may be configured to measure the pressure of the water above the energy transmitting device 1. This may be achieved by isolating the sensor 16 from the sediments, but not from the water. The pressure of the water may then be used to calculate the height of water between the water surface level and the level of the sensor 16.

In another example, at least one imaging sensor 16 (e.g., a camera) may be used to determine the height of the waves.

At least one pressure sensor 16 may be provided on the energy transmitting device 1 to measure a pressure inside the inflatable element 12. If additional inflatable element 12 are present, these elements may also comprise pressure sensors 16. Preferably, the pressure sensor 16 is installed inside the feeding pipe 131 or the pressure management unit.

Several pressure sensors 16 may be provided at different locations of the energy transmitting device 1. For instance, at least one pressure sensor 16 may be located proximate to a central area of the upper surface 11a and at least one pressure sensor 16 proximate to a peripheral area thereof (FIG. 1).

In alternative or in addition to the pressure sensor 16 described hereinabove, the energy transmitting device 1 may comprise a measuring device for measuring the height h_{G} of the layer of granular medium 2. Preferably, said measuring device comprises:
at least one small bag (defining for example a volume ranging between 0.3 and 2 liters) connected to a pressurized gas generator, the bag being located in the envelope 11 or, preferably, external to the envelope (e.g., above);
a pressure sensor 16 configured to measure the pressure in the at least one bag; and
a computing unit configured to calculate the height h_{G} of the layer of granular medium 2 based on the pressure sensor measurement when said small bag is inflated and deflated, and on a calibration curve.

Alternatively, the height h_{G} of the layer of granular medium 2 may be derived from the pressure waveforms collected by one or more pressure sensor 16, and the estimated size of the waves at a given time (e.g., as provided by a weather forecast or by a camera connected to a computer). In this case, said height h_{G} may be calculated using a model which describes a relationship between a wave passage and a corresponding change in the amplitude and/or phase of the pressure waveform, wherein the change in the amplitude and/or phase is a function of depth in the granular medium 2.

In alternative, the measuring device may comprise at least two sensors: a first reference sensor, installed on the seabed or slightly buried at a known depth, said first sensor acquiring a signal relating to the pressure variation, which is affected by the passing waves, and a second target sensor (or several target sensors) at the location at which the height h_{G} of the granular medium is to be determined. This second target sensor is buried under a layer of granular medium of unknown depth. In This embodiment, the height h_{G} of the granular medium 2 may be determined by processing the phase offsets and amplitude variations (e.g., the amplitude decrease) of the signals acquired by the reference and target sensor(s).

The measurement of the height h_{G} of the layer of granular medium 2 advantageously provides information about the granular medium topology, and on the effect of the energy transmitting device 1 thereon. Moreover, it allows to monitor the depth of the energy transmitting device 1 within the granular medium 2. Therefore, by measuring the height h_{G} of the layer it is possible to predict and prevent an unwanted protrusion of the energy transmitting device 1 therefrom (especially when the layer of granular medium 2 is eroded by currents) and to avoid that the energy transmitting device 1 is buried too deep. A measurement of the partial pressure of the water contained in the granular medium may also be performed to avoid the energy transmitting device 1 from being buried too deep.

For instance, if the energy transmitting device 1 comprises one or more pipes, the height monitoring allows to verify that the depth of the energy transmitting device 1 within the granular medium 2 does not exceed what the length of the pipe allows.

The energy transmitting device 1 may comprise a computing unit. For instance, the computing unit may be configured to receive signals and/or images from the sensors, and to calculate the environmental parameters therefrom.

The computing unit may also be configured to control the variation of the internal volume 110 (e.g., by controlling the injection device 13 or the switching of the energy transmitting device 1 from one configuration to another) on the basis of measured or reference parameters (e.g., a target height of the layer of granular medium 2). The computing unit may be near the device 1 (for example on the land), or can be remotely connected to sensors and valves, by small tubes or/and electrical wires.

The energy transmitting device 1 may also comprise a memory, preferably a processor-readable non-transitory memory. The memory may be configured to store the calculated and/or reference parameters. The memory may also comprise instructions which are readable and executable by the computing unit.

The energy transmitting device 1 of the invention may comprise a release device 14. One exemplary release device 14 is shown in FIG. 1.

The release device 14 of FIG. 1 comprises a single outlet 141 near the bend 133 of the feeding pipe 131.

Alternatively, the release device 14 may comprise more than one outlet 141, for instance several small outlets 141 along the conduit 131 and, when present, the transportation pipe 171. This is particularly advantageous to prevent the lower part of the conduit 131 from getting stuck during the descent or ascent of an energy transmitting device 1 buried at a large depth.

The release device 14 ensures that any conduit connected to the energy transmitting device 1 moves into the granular medium 2 as the energy transmitting device 1 ascends or descends therethrough.

Examples of conduits comprise: hoses, power wires, pipes, cables, cords and the like. For instance, as aforementioned, a feeding pipe 131 or, when present, a transportation pipe 171 may be connected to the inflatable element 12. In this case, the release device 14 may have an outlet 141 in proximity of said feeding pipe 131 and/or, when present, the transportation pipe 171. Moreover, if the energy transmitting device 1 comprises sensors and/or a computing unit, these may comprise dedicated cables ensuring power supply or data transfer, and tubes relaying information using compressed air.

In all these embodiments, the release device 14 ensures that the conduits follow the energy transmitting device movements, thereby minimizing the risk of damaging said conduits.

The release device 14 preferably comprises a pressurized fluid generator 142 and at least one outlet 141 configured to inject the pressurized fluid into the granular medium 2, in proximity of the conduit. Optionally, several outlets 141 may be provided. Optionally, the release device 14 and the conduit may be tied or clamped together, in order to ensure that the outlet 141 of the former is maintained close to the latter.

The injection of fluid in the granular medium 2 through the outlet 141 generates a mixture of fluid and granular medium 2. Said mixture exhibits fluid-like properties; therefore, the movement of a conduit therein is easier than inside a static granular medium 2.

The injection of fluid may be synchronous with the energy transmitting device configuration. For instance, it may be injected when the energy transmitting device 1 is intended to move vertically within the granular medium 2 (e.g., in the ascent configuration, or during the burying of the energy transmitting device 1), and not when the energy transmitting device 1 is in a stable position in the granular medium 2 (e.g., in the energy recovery configuration). This embodiment allows to limit the number of injections of fluid and, therefore, the power consumption.

The energy transmitting device 1 of the invention may comprise a burying device 15.

Said burying device 15 preferably comprises a pressurized fluid generator 152 and at least one outlet 151 configured to inject the pressurized fluid into the granular medium 2 below the lower surface 11b of the envelope 11 (FIG. 1).

The burying device 15 advantageously allows the sinking of the energy transmitting device 1 in the granular medium 2. More precisely, the injection of fluid in the granular medium 2 through the outlet 151 generates a flow of a mixture made of fluid and granular medium 2. Preferably, the burying device 15 is configured to inject a mixture of air and water. This may be obtained for instance with a compressor and a pump, both of them feeding a same conduit of the burying device 15. The pump and the compressor may comprise a non-return valve in order to protect them (e.g., from backflow and reverse flow).

The flow of said two-phase mixture away from the lower surface 11b of the envelope 11 allows the sinking of the energy transmitting device 1 in the granular medium 2.

This embodiment advantageously allows to obtain an energy transmitting device 1 which is self-burying and capable of reaching a desired depth within the granular medium 2, without any excavation.

In some cases, a predefined weight or pressure, for example of 0.02 bar, may be applied on top of the upper surface to facilitate the burying process when it begins.

The maximum depth of the energy transmitting device 1 in the granular medium 2 may be determined based on the length of the tubes, hoses and cables, the pressure of the fluid, and/or on the available depth of soft granular medium 2.

Preferably, the pressurized fluid generator 152 of the burying device 15 is configured to inject a fluid at a pressure which is at least equal to the pressure of the granular medium 2 at the target depth plus 0.5 bar.

For example, the density of a wet a granular medium 2 such as wet sand being around 2000 kilograms per cube meter, the minimum pressure of the injected fluid injected may be around 0.2 bar+0.5 bar under one meter of wet sand (with no water on top), whereas higher pressures may be selected for burying the energy transmitting device 1 at greater depths. Burying devices of large dimensions requires higher pressures. The flow and pressure required depend on the size of the device.

The pressurized fluid generator 152 of the burying device 15 may be configured to inject the pressurized fluid at a controlled pressure, ranging between 0 bar and 20 bar.

The outlet 151 of the burying device 15 may comprise nozzles directed towards different directions. Those nozzles are preferably organized by pairs so that the nozzles of each pair are separated by an angle of 180°, i.e., they are diametrically opposed. This ensures that the forces and torques exerted by the pressurized fluid exiting from said outlet 151 are in opposite directions, thereby avoiding that the outlet 151 is displaced over time. For large devices, several pairs of nozzles may be required, depending on the flow and pressure of the pressurized fluid. It can be advantageous to direct said fluid to different pairs of nozzles in successive order, so that each nozzle can receive the maximum amount of power at a given time. A quick succession of on and off periods is also advantageous.

Moreover, the burying device 15 may be tied or clamped together with one or more conduits disposed at the periphery of the energy transmitting device 1. This allows a better burying efficiency of the overall energy transmitting device 1.

In the example of FIG. 1, the energy transmitting device 1 comprises a release device 14 and a burying device 15 which are connected to respective generators 142, 152 of pressurized fluid. In this case, the injected fluids may be different (e.g., one generator 142, 152 may be configured to generate pressurized air and another generator 142, 152 may be configured to generate pressurized water).

However, the burying device 15 and/or the release device 14 may be connected to a same generator 152, 142 of pressurized fluid. This allows to reduce the weight and volume of the energy transmitting device 1.

The release device 14 and/or the burying device 15 may comprise a pipe connecting the generator of pressurized fluid 142, 152 with the outlets 141, 151. These pipes may comprise a bend 143, 153 similar to the bend 133 of the feeding pipe 131.

As aforementioned, the energy transmitting device 1 may comprise one or more sensors. In this case, the burying device 15 may be controlled on the basis of the sensor measurements.

As explained above, the energy recovery configuration allows a deformation of the flexible envelope 11 towards the at least one inflatable element 12 to generate electricity 172 via the at least one energy converting device 17. Several embodiments of energy converting device 17 are described hereafter.

In a first embodiment represented in FIGS. 7A and 7B, the energy converting device 17 may comprise an electroactive polymer or elastomer allowing the conversion of the mechanical deformation of the flexible envelope 11 by the impinging of the wave into electricity 172 without need of recovering the energy that may be transferred to the fluid inside the flexible envelope 11. This first embodiment may take the form of several variants. First, the flexible envelope 11 comprises the electroactive polymer or elastomer (FIG. 7B). The electricity 172 is thus directly generated by the deformation of the flexible envelope 11. Second, the inflatable elements 12 comprise the electroactive polymer or elastomer. The deformation of the flexible envelope 11 implies a deformation of the inflatable elements 12 therefore generating electricity 172. Thirdly, an electroactive layer is disposed between the flexible envelope 11 and the inflatable elements 12 comprises the electroactive polymer or elastomer. The deformation of the flexible envelope 11 implies a deformation of the electroactive layer therefore generating electricity 172.

As the wave continues to pass over the energy transmitting device 1 and pressure decreases inside the envelope 11 (i.e., the peak of the wave 14a has passed), the inflatable element 12 is reinflated so that the inflatable element 12 is able to be deformed at the next wave (FIG. 7A).

Advantageously, when the volume of each inflatable element 12 or the flexible envelope 11 is too small to allow compression of the fluid comprised in the inflatable elements 12 or the flexible envelope 11 so that the amplitude of the deformation of the inflatables elements 12 can reach a significant portion of their maximum deformation range (for example 20%), each inflatable element 12 or the flexible envelope 11 comprises an outlet 121 so that, when a wave is impinging, the fluid comprised in the inflatable element 12 or the flexible envelope 11 is freely expulsed though the outlet 121 in order to allow a maximum deformation of the inflatable element 12.

In a second embodiment illustrated on FIGS. 3A and 3B, each inflatable element 12 comprises an outlet 121 and at least one of the inflatable elements 12 is fluidically connected to the at least one energy converting device 17 via the outlet 121. FIG. 3A illustrates the moment before a wave impinges on the energy transmitting device 1. When a wave impinging on the energy transmitting device 1 flows over the flexible envelope 11, as illustrated in FIG. 3B, the pressure on the fluid inside said inflatable element 12 is increased so that the fluid is forced out of said inflatable element 12 at the outlet 121 as represented by the solid arrow. This occurs when the pressure on the external side of the flexible envelope 11 (outside the internal volume) is higher than the pressure inside said inflatable element 12 and provides a very cost effective, low inertia and responsive way to extract and transmit energy from a wave. Therefore, the deformation of the flexible envelope 11 assists the conversion of potential and kinetic energy of the wave to pressure and kinetic energy of the fluid. The fluid expulsed from the inflatable element 12 via the outlet 121 passes through energy converting device 17 which converts its kinetic energy into mechanical energy and/or electricity as represented in FIGS. 3A and 3B. When a wave exerts pressure on the upper surface 11a thereby pressurizing the fluid of said inflatable element 12, said fluid is forced out of the at least one inflatable element 12 at the outlet 121 to the energy converting device 17 as represented by the solid arrow in FIG. 3B. As the wave continues to pass over the energy transmitting device 1 and pressure decreases inside the envelope 11 (i.e., the peak of the wave 14a has passed), the inflatable element 12 is reinflated so that the energy transmitting device 1 may transfer the energy of the next wave.

The at least one inflatable element 12 is configured to contain a fluid such as air of water The outlet 121 of the at least one inflatable element 12 may either lead into the flexible envelope 11 or outside the flexible envelope 11 as represented in FIGS. 1-4B. The outlet is preferably placed on the lower surface 11b or at the interface between the lower surface 11b and the upper surface 11a.

When the outlet 121 leads into the flexible envelope 11, the energy converting device 17 may be disposed inside the flexible envelope 11. Preferably, the outlet 121 leads outside the flexible envelope 11 and the energy converting device 17 is disposed outside the flexible envelope 11.

In order to transport the fluid from the at least one inflatable element 12 to the energy converting device 17, the wave energy converter 100 may further comprise at least one transportation pipe 171 comprising a proximal end in fluidic connection with the outlet 121 of the at least one inflatable element 12 and a distal end in fluidic connection with the energy converting device 17 so that the fluid is transported through the transportation pipe 171 back and forth. This is advantageous because the energy converting device 17 may be disposed in a different location from the energy transmitting device 1. Preferably, the transportation pipe 171 has a large diameter, for example, half a meter. The transportation pipe 171 may be the same as the feeding pipe 131. When it is distinct, the feeding pipe itself does not require a large diameter.

The energy converting device 17 of this second embodiment may comprise power take-off (PTO) converter. For example, the PTO may be an impeller, an air turbine or a hydro turbine allowing to convert the kinetic energy of the fluid passing through it into mechanical energy. For example, the mechanical energy is then converted into electricity 172. The energy converting device 17 may also comprise an electricity 172 generator allowing to convert the kinetic energy of the fluid passing through it into electricity 172 (direct electrical drive system) or to convert the mechanical energy provided by the PTO into electricity 172 (rotary electrical generator). The wave energy converter 100 can therefore be used a source of renewable energy by extracting the energy from the waves to convert it into electricity 172.

The wave energy converter 100 in this second embodiment may comprise an assembly of at least two energy transmitting devices 1, the assembly being fluidically connected to at least one energy converting device 17 via the outlet 121 of at least one inflatable element 12. As represented in FIGS. 5A and 5B, the energy converting device 17 is preferably fluidically connected to all the energy transmitting devices 1. In order to increase the efficiency of the assembly, one energy transmitting devices 1 should be placed a few dozen meters onshore of the other one. The ideal distance is half the wavelength of the predominant swell.

In one example represented in FIG. 5A, the assembly may be an array of energy transmitting devices 1. Each energy transmitting device 1 of the array is connected to at least one other energy transmitting devices 1 of the array and to at least one energy converting device 17.

In another example represented in FIG. 5B, the assembly comprises at least two energy transmitting devices 1, each energy transmitting device 1 being fluidically connected to one common energy converting device 17.

Preferably, the fluid should travel through the energy converting device(s) 17 always in the same direction (i.e., for example, always from the energy transmitting device A to the energy transmitting device B). To do so, the assembly may comprise at least one one-way valve allowing the displacement of the fluid in only one direction in the section(s) of the assembly that contain the energy converting device(s) 17. This allows a more efficient operation of the energy converting device(s) 17. Alternatively, assembly comprises a reversible PTO, for example a PTO using a wells turbine, allowing the fluid to move in one direction or another without changing the direction of rotation of the turbine.

In a third embodiment represented in FIG. 6A, the energy converting device 17 comprises at least one cylinder. Each cylinder comprises a piston 191 and a chamber 192, the chamber receiving a part of the piston 191. The piston 191 is disposed within the inflatable element 12. The chamber 192 may be either at least partially comprised in the inflatable element 12 or disposed totally outside the inflatable element 12. In this third embodiment, it may be advantageous to provide the inflatable element 12 with different values of rigidity/flexibility of the material along its surface. Preferably, the area of the inflatable element 12 in contact with the piston 191 is rigid and is surrounded with an area of semi-flexible material. The rest of the inflatable element 12 is maintained flexible to ease the deformation.

When a wave impinging on the energy transmitting device 1 flows over the flexible envelope 11, the inflatable element 12 is deformed and the pressure on the piston 191 inside said inflatable element 12 is increased so that the piston 191 is pushed through the chamber. Therefore, the deformation of the flexible envelope 11 assists the conversion of potential and kinetic energy of the wave to pressure and mechanical energy. As the wave continues to pass over the energy transmitting device 1 and pressure decreases inside the envelope 11 (i.e., the peak of the wave 14a has passed), the inflatable element 12 is reinflated so that the energy transmitting device 1 may transfer the energy of the next wave (FIG. 6A).

The cylinder may be a linear generator. The energy converting device 17 is therefore configured to generate electricity directly from piston movements due to the wave impinging.

Alternatively, the cylinder is a pneumatic or hydraulic cylinder, preferably a double acting cylinder. Each chamber 192 is able to comprise a piston fluid such as air or oil. When a wave impinging on the energy transmitting device 1 flows over the flexible envelope 11 (FIG. 6B), the inflatable element 12 is deformed and the pressure on the piston 191 inside said inflatable element 12 is increased so that the piston 191 is pushed through the chamber (vertical arrow in FIG. 6B) and the fluid inside the chamber 192 is forced out (horizontal arrow in FIG. 6B). Therefore, the deformation of the flexible envelope 11 assists the conversion of potential and kinetic energy of the wave to pressure and mechanical energy and thus in kinetic energy of the fluid of the pneumatic cylinder.

In case of a double acting cylinder, the chamber 192 is refilled with fluid to assist the rise of the piston 191. Disposing the whole chamber 192 outside the inflatable element 12 advantageously allows a maximum piston stroke.

The third embodiment could include any other suitable arrangement or implementation of a cylinder in the energy converting device 17. For example, the cylinder may comprise a piston having an end connected to a linear generator, such as a direct-drive permanent-magnet linear generator, which directly generates electricity.

Advantageously, when the volume of each inflatable element 12 or the flexible envelope 11 is too small to allow the compression of the fluid comprised in the inflatable elements 12 or the flexible envelope 11 to allow the amplitude of the piston's movement to reach a target range (for example 50% of its maximum range), each inflatable element 12 comprising a cylinder or the flexible envelope 11 comprises an outlet 121 so that, when a wave is impinging, the fluid comprised in the inflatable element 12 is freely expulsed though the outlet 121 in order to allow a maximum deformation of the inflatable element 12.

The energy converting device 17 may further comprise power take-off (PTO) converter. For example, the PTO may be an impeller, an air turbine or a hydro turbine allowing to convert the kinetic energy of the piston fluid passing through it into mechanical energy. For example, the mechanical energy is then converted into electricity 172. The energy converting device 17 may also comprise an electricity generator allowing to convert the kinetic energy of the fluid passing through it into electricity 172 (direct electrical drive system) or to convert the mechanical energy provided by the PTO into electricity 172 (rotary electrical generator).

The present invention also relates to a method 200 of converting wave energy into electricity and/or mechanical energy.

FIG. 8 is a flowchart illustrating the main steps of the method 200.

The method comprises the steps of
burying 201 at least one flexible envelope 11 comprising a fluid in a variable internal volume 110 at a predetermined depth in a granular medium 2, and
converting 202 the potential and kinetic energy of the wave into mechanical energy and/or electricity with the at least one energy converting device 17 when a wave flows over said flexible envelope 11.

During the burying step 201, the flexible envelope 11 is buried so that it is covered by a layer of granular medium 2 (protection configuration). The burying should be deep enough to avoid the flexible envelope 11 to go back up when switching to the energy recovery configuration wherein the internal volume 110 of the flexible envelope 11 is greater than in the protection configuration. The minimum depth depends on the size of the flexible envelope 11: a larger flexible envelope 11 should be buried at a minimum depth larger than a smaller flexible envelope 11. The burying of the flexible envelope 11 may be performed by the same means as those used in the descent step 205b detailed hereafter.

In one embodiment, the method further comprises a step 204 of varying internal volume 110 by inflating or deflating the flexible envelope 11 via the inflation or deflation of the inflatable element 12 comprised in said flexible envelope 11, respectively.

In one embodiment, the method may comprise, after the burying 201, a step 204 of inflating at least one of the inflatable elements 12 until the height of the layer of granular medium 2 is less than 50 centimeters, i.e., at least one point of the upper surface 11a is covered by a height of less than 50 centimeters of granular medium, and said height is also less than around 20% of the width of the inflatable element 12 used to switch from the protection configuration to the energy recovery configuration. In other words, the energy transmitting device 1 switches from the protection configuration to the energy recovery configuration thereby allowing potential and kinetic energy of the wave to be converted to electricity and/or mechanical energy during the converting step 202. Said height of granular medium 2 is advantageous because it is small enough to allow the granular medium to behave like a fluid when in motion in certain conditions. When the waves are small, and the edges of the envelop 11 are buried deep enough, the height of granular medium 2 can be zero, and a portion of the upper surface 11a of the envelope may stick out of the granular medium 2.

In one embodiment, the method may comprise, a step 204 of deflating at least one of the inflatable elements 12 so that the energy transmitting device 1 switches from the energy recovery configuration to the protection configuration thereby, for example, protecting the energy transmitting device 1 from any damage.

The method 200 can optionally further comprise a step 205 of vertically displacing the flexible envelope 11. The vertical displacement may be the ascent 205a or descent 205b of the flexible envelope 11 through the granular medium. The ascent 205a and descent 205b may be performed independently or alternatively.

The ascent 205a of the flexible envelope 11 through the granular medium 2 is performed by switching from the protection configuration or the energy recovery configuration to the ascent configuration in which the edges of the envelope (in particular the bottom part of the edges) rise and the lower surface 11b of the envelope is vertically deformed, allowing the flexible envelope 11 to ascend through the granular medium 2, because of the migration of the granular medium 2, around said edges, below the envelope 11.

This ascent 205a may comprise several phases. For instance, the ascent 205a may comprise a first phase of increasing the internal volume 110 to a third volume and a second phase of decreasing said internal volume to a fourth volume smaller than the third volume. In this case, the granular medium 2 which migrates below the envelope 11 during the first phase allows the energy transmitting device to stabilize higher within the granular medium during the second phase. These first and second phases may be alternated and repeated for a predetermined number N of times, until the envelope 11 reaches the desired depth within the granular medium 2 or emerges therefrom.

The descent 205b of the flexible envelope 11 through the granular medium 2 is performed by injection of a pressurized fluid into the granular medium 2 below the envelope. The injection of said fluid generates a flow of a mixture of fluid and granular medium 2 that has a lower density than the granular medium 2 on top of the flexible envelope 11. This allows the flexible envelope 11 to descend through the granular medium 2, provided that it is flexible enough to stretch and to be curved so that the bottom of the flexible envelope 11 sinks down in the mixture of fluid and granular medium 2. The mixture of fluid and granular medium 2 may be generated from the center to the edge of the flexible envelope 11 leading the bottom of the flexible envelope 11 to sink down all along its surface and thus allowing the flexible envelope 11 to descend. The injected pressurized fluid is advantageously biphasic. And is preferable a mix or air and water. The presence of air increased the pressure difference between the fluid mixture circulating under the bottom of the flexible envelope 11 and the granular medium immediately above the flexible envelope 11. The presence of water increases the kinetic energy of the fluid mixture, and allows it to move sand towards the border of the envelope 11.

The method may also comprise a step 207 of measuring a height h_{G} of the layer of granular medium 2 above the envelope 11.

The measured height h_{G} may be compared with a target height. In this case, the step 205 of vertically displacing the flexible envelope 11 may be implemented in response to retroactive feedback.

The method may also comprise a step 206 of measuring a flow parameter relating to the water and/or the granular medium above the buried envelope 11. The flow parameter may relate for instance to sediment layer height, average water column height, wave height, wavelength, wave period, wave steepness and the like. These parameters may be derived from sensor measurements, and optionally be used to control one or more steps of the method. These parameters comprise:
an absolute or a relative pressure exerted by the granular medium 2;
an absolute or a relative partial pressure exerted by fluids in the granular medium 2 (for example the partial pressure of water in wet sand);
a sediment transport velocity;
a tidal coefficient;
a granularity parameter (e.g., grain average size or size distribution) of the layer of granular medium 2;
a height of a water column or a water level relative to a reference point;
a direction of the sea flow;
a parameter relating to turbulence, such as kinetic energy or viscous dissipation;
an acoustic intensity;
a wind direction, orientation, speed and/or force;
a wavelength, height, direction, period and/or steepness of a wave;
a slope of the sea floor or of the shoreline
a type of tide;
a type of wave breaking; and/or
a deformation of a surface of the envelope 11.

In the embodiment wherein the method 200 is performed using the wave energy converter 100 described above, the step 204 of inflation of at least one the inflatable element 12 may also be implemented in response to retroactive feedback. In some cases, this step 204 may be user-initiated.

In this case also, the number N of times performing the ascent 205a may be calculated based on said parameter of the granular medium 2 and/or flow parameter. For instance, the number N of times or the variation of the internal volume 110 constituting the ascension step may be controlled using a machine learning algorithm trained on said parameter.

The method may further comprise a step of retrieving the flexible envelope 11.

A computer program may be provided comprising program code instructions which, when executed by a computer, cause the computer to carry out at least the step of varying the internal volume 110 according to any one of the embodiments described hereabove.

### BRIEF DESCRIPTION OF THE DRAWINGS

The invention will be better understood with the attached figures, in which:

FIG. 1 is a schematic representation of a wave energy converter of the present invention according to one particular embodiment.

FIG. 2A is a schematic representation of the protection configuration of the energy transmitting device.

FIGS. 2B and 2C are schematic representations of energy recovery configurations wherein the internal volume represented in FIG. 2C is larger than the internal volume represented in FIG. 2B.

FIG. 3A is a schematic representation of the energy transmitting device in its first embodiment before the impinging of a wave.

FIG. 3B is a schematic representation of the energy transmitting device in its first embodiment during the impinging of a wave.

FIG. 4A is a schematic representation of the ascent configuration of the energy transmitting device.

FIG. 4B is a schematic representation of the ascent configuration of the energy transmitting device in an alternative embodiment wherein the energy transmitting device also comprises an additional inflatable element.

FIG. 5A is a schematic representation of an array configuration of energy transmitting devices.

FIG. 5B is a schematic representation of a linear configuration of energy transmitting devices in a linear configuration.

FIG. 6A is a schematic representation of the energy transmitting device in its second embodiment before the impinging of a wave.

FIG. 6B is a schematic representation of the energy transmitting device in its second embodiment during the impinging of a wave.

FIG. 7A is a schematic representation of the energy transmitting device in its third embodiment before the impinging of a wave.

FIG. 7B is a schematic representation of the energy transmitting device in its third embodiment during the impinging of a wave.

FIG. 8 is a flowchart representing the main step of a method for converting wave energy into electricity and/or mechanical energy.

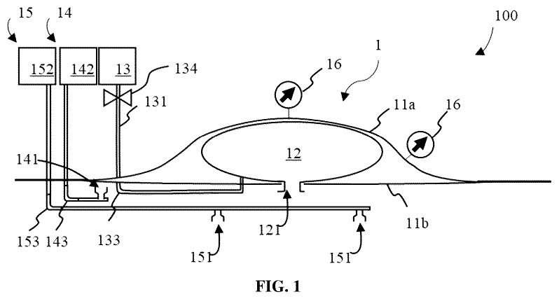

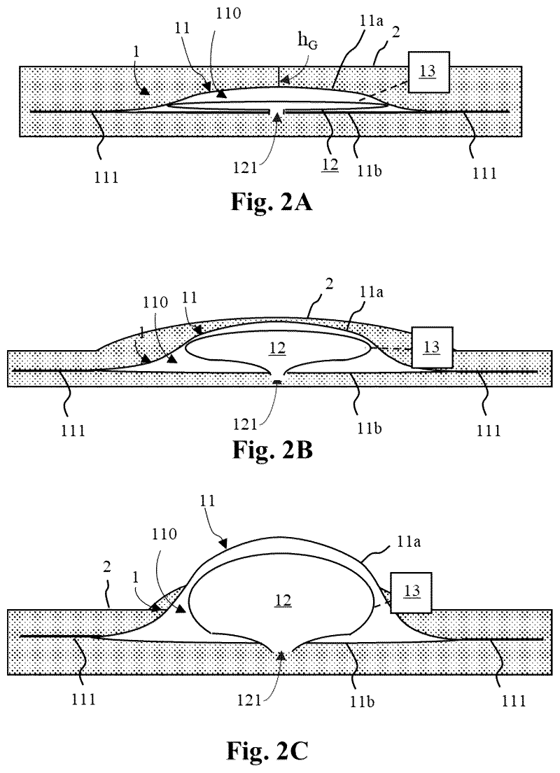

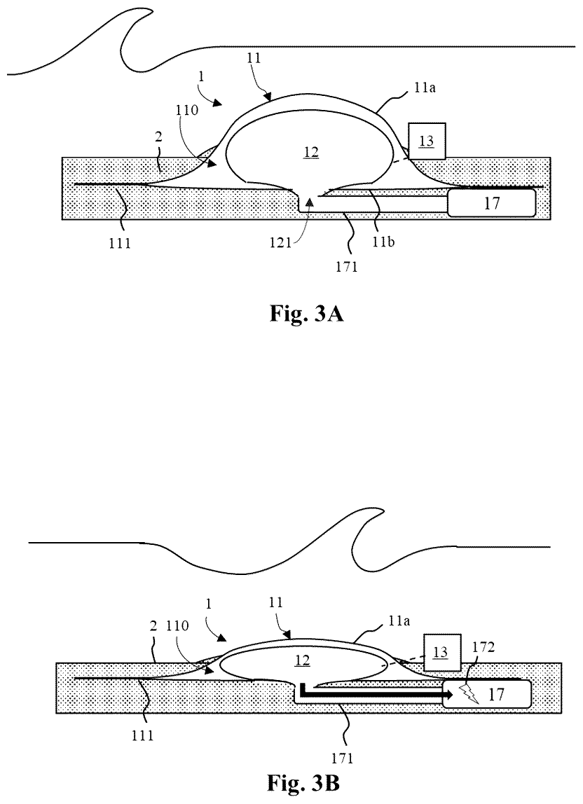

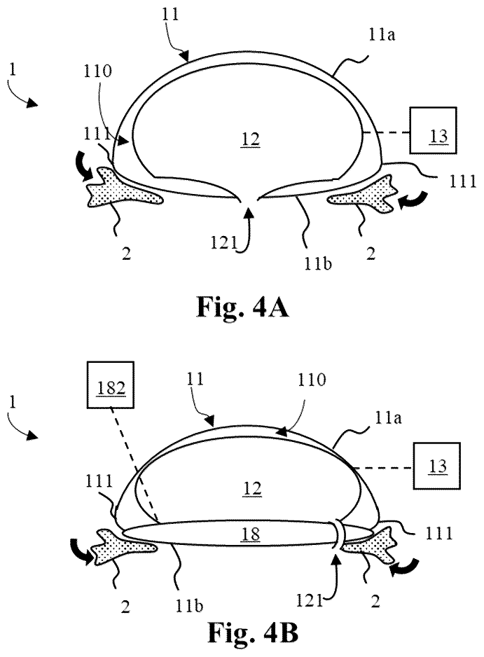

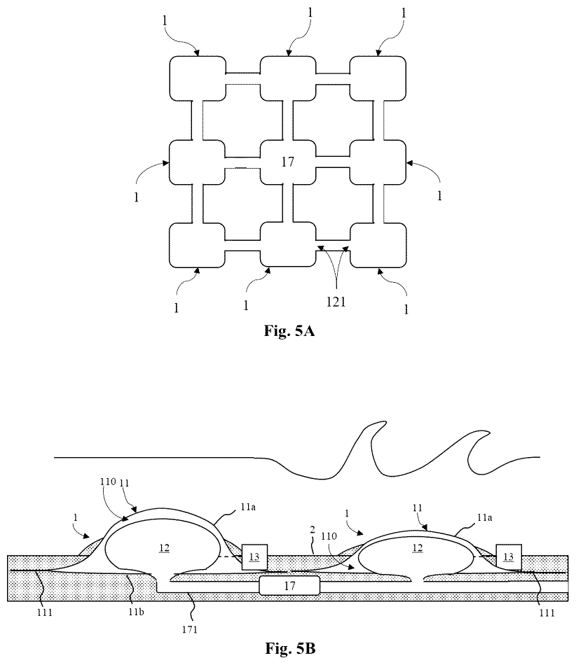

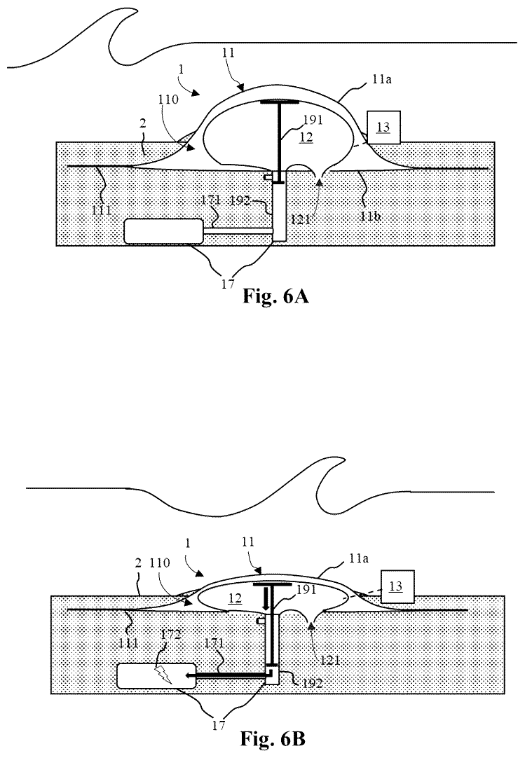

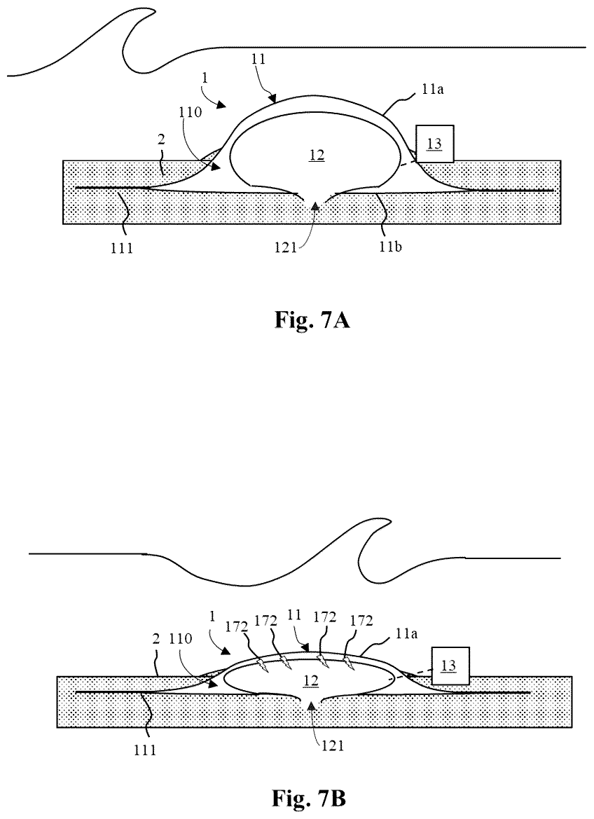

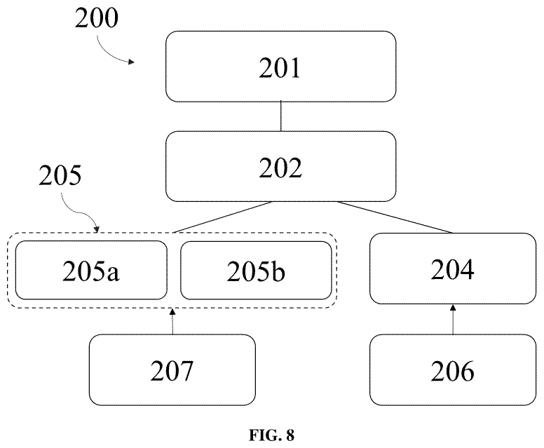

### REFERENCES

100—wave energy converter
1—energy transmitting device
11—envelope
11a—upper surface
11b—lower surface
110—internal volume
111—edges
12—inflatable element
121—outlet
13—injection device
131—feeding pipe
133, 143, 153—bend
134—valve
14—release device
141, 151—outlets
142, 152, 182—pressurized fluid generator
15—burying device
16—pressure sensor
17—energy converting device
171—transportation pipe
172—Electricity
18—additional inflatable element
191—Piston
192—chamber
2—granular medium
h_{G}—height of the layer of granular medium
200—method
201—burying at least one flexible envelope
202—converting wave energy into mechanical energy and/or electricity
204—inflation of the inflatable element
205—vertically displacing the flexible envelope
205a—ascent of the flexible envelope through a granular medium
205b—descent of the flexible envelope through a granular medium
206—measuring a flow parameter
207—measuring a height of the layer of granular medium

1-19. (canceled)

20. A wave energy converter comprising:
at least one energy transmitting device configured to be disposed within a granular medium, such as sand or sediment, the energy transmitting device comprising:
a flexible envelope forming an internal volume and comprising an upper surface and a lower surface; and
at least one inflatable element configured to contain a fluid and housed in the internal volume so as to be interposed between the upper surface and the lower surface; and
at least one energy converting device associated to said at least one inflatable element and configured to produce energy upon actuation;
wherein the energy transmitting device presents an energy recovery configuration allowing a deformation of the flexible envelope towards said at least one inflatable element to deform said at least one inflatable element when a wave impinging on the energy transmitting device flows over said flexible envelope, so that said deformation of the flexible envelope actuates the at least one energy converting device.

21. The wave energy converter according to claim 20, wherein the energy converting device comprises at least one cylinder comprising a piston disposed within the inflatable element and a chamber receiving a part of the piston, a deformation of the flexible envelope increasing pressure on the piston thereby actuating the at least one energy converting device.

22. The wave energy converter according to claim 20, wherein the energy converting device comprises an electroactive polymer, in particular an electroactive elastomer, allowing the conversion of the mechanical deformation of the flexible envelope by the impinging of the wave into electricity.

23. The wave energy converter according to claim 20, wherein each inflatable element comprises an outlet and the at least one energy converting device is in fluidic connection with said at least one inflatable element via the outlet and wherein the deformation of the flexible envelope towards at least one of the inflatable elements increases pressure on the fluid and forces it out of said at least one inflatable element at the outlet to actuate the at least one energy converting device.

24. The wave energy converter according to claim 23, further comprising an assembly of at least two energy transmitting devices, the assembly being fluidically connected to the at least one energy converting device via the outlet of the inflatable elements.

25. The wave energy converter according to claim 23, further comprising at least one transportation pipe comprising a proximal end being in fluidic connection with the outlet of said at least one inflatable element and a distal end being in fluidic connection with the energy converting device so that the fluid is transported from said at least one inflatable element to the energy converting device through the transportation pipe.

26. The wave energy converter according to claim 20, wherein the energy transmitting device is configured to switch from a protection configuration in which at least one inflatable element is inflated so that a first distance is measured between the upper surface and the lower surface to the energy recovery configuration in which said at least one inflatable element is inflated so that a second distance is measured between the upper surface and the lower surface, the second distance being greater than the first distance, and vice-versa.

27. The wave energy converter according to claim 26, wherein in the protection configuration the upper surface has a first curvature, in the energy recovery configuration the upper surface has a second curvature greater than the first curvature.

28. The wave energy converter according to claim 26 wherein, in the protection configuration, the upper surface is covered by a layer of granular medium having a first height and, in the energy recovery configuration, the upper surface is at least partially covered by a layer of granular medium having a second height, the second height being smaller than the first height.

29. The wave energy converter according to claim 26, wherein the energy transmitting device is further configured to switch from the protection configuration or the energy recovery configuration to an ascent configuration in which at least one of the inflatable elements is inflated so that the distance between the upper surface and the lower surface is larger than the second distance so as to elevate the both the top and the bottom part of the edges of the envelope for allowing the energy transmitting device to ascend through the granular medium.

30. The wave energy converter according to claim 20, further comprising a measuring device for measuring the height of the layer of granular medium above the energy transmitting device, the measuring device comprising at least one pressure sensor.

31. The wave energy converter according to claim 20, wherein the energy transmitting device further comprises a burying device, said burying device comprising a pressurized fluid generator and at least one outlet configured to inject the pressurized fluid into the granular medium below the lower surface of the envelope to allow the energy transmitting device to descend through the granular medium.

32. The wave energy converter according to claim 20, wherein the flexible envelope is leak-tight, so as to impede the passage of the granular medium therethrough.

33. The wave energy converter according to claim 20, further comprising an injection device configured to fill at least one of the inflatable elements with the fluid and comprising at least one feeding pipe comprising an upstream portion adapted to receive a fluid and a downstream portion connected to said at least one inflatable element, the upstream portion and the downstream portion being connected to each other by a bend and/or the upstream and downstream portions comprising micronozzles, so as to prevent kinking of the feeding pipe between the upstream and the downstream portion.

34. The wave energy converter according to claim 20, wherein the energy transmitting device further comprises an additional inflatable element positioned below or embedded in the lower surface of the envelope and a pressurized fluid generator for inflating the additional inflatable element with a fluid, wherein in the ascent configuration said additional inflatable element is inflated so as to elevate the lower surface to allow the energy transmitting device to ascend through the granular medium.

35. The wave energy converter according to claim 20, wherein the energy converting device comprises an electricity generator.

36. A method of converting wave energy into electricity and/or mechanical energy using the wave energy converter according to claim 20, the method comprising burying the at least one flexible envelope comprising a fluid in the internal volume at a predetermined depth in a granular medium, and converting the wave energy into mechanical energy and/or electricity with the at least one energy converting device when a wave flows over said flexible envelope.

37. The method of converting wave energy according to claim 36, further comprising vertically displacing the flexible envelope, said vertically displacing the flexible envelope comprising:
ascent by vertically deforming the flexible envelope; and/or
descent by injecting a pressurized fluid into the granular medium below the flexible envelope.

38. The method of converting wave energy according to claim 36, further comprising a varying the internal volume by inflating or deflating the flexible envelope.
